(19) United States
(12) Patent Application Publication
(10) Pub. No.: US 2021/0334614 A1
(43) Pub. Date: Oct. 28, 2021

(54) Credit Card Authenticator Transceiver Apparatus

(71) Applicant: George Louis, Kokomo, IN (US)

(72) Inventor: George Louis, Kokomo, IN (US)

(21) Appl. No.: 16/860,923

(22) Filed: Apr. 28, 2020

(51) Int. Cl. G06K 19/07; G06K 19/04; G06K 19/06

(52) U.S. Cl. CPC G06K 19/0718; G06K 19/06187; G06K 19/0719; G06K 19/045

(57) ABSTRACT

A credit card authenticator transceiver apparatus for wirelessly and securely sending funds includes a card body. A magnet strip is coupled to a back side of the card body proximal a top edge. A CPU is coupled within the card body. A battery is coupled within the card body and is in operational communication with the CPU. An auxiliary chip is coupled to a front side of the card body adjacent a left edge. The auxiliary chip is in operational communication with the CPU. A camera is coupled to the card body and extends through the front side. The camera is in operational communication with the CPU. A solar cell strip is coupled to the front side of the card body and is in operational communication with the CPU. A transceiver is coupled within the card body and is in operational communication with the CPU.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to credit cards and more particularly pertains to a new credit card for wirelessly and securely sending funds.

### BRIEF SUMMARY OF THE INVENTION

An embodiment of the disclosure meets the needs presented above by generally comprising a card body having a front side, a back side, a top edge, a bottom edge, a left edge, and a right edge. A magnet strip is coupled to the back side of the card body proximal the top edge. A CPU is coupled within the card body. A battery is coupled within the card body and is in operational communication with the CPU. An auxiliary chip is coupled to the front side of the card body adjacent the left edge. The auxiliary chip is in operational communication with the CPU. A camera is coupled to the card body and extends through the front side. The camera is in operational communication with the CPU. A solar cell strip is coupled to the front side of the card body and is in operational communication with the battery. A transceiver is coupled within the card body and is in operational communication with the CPU.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a credit card authenticator transceiver apparatus according to an embodiment of the disclosure.

FIG. 2 is a bottom plan view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

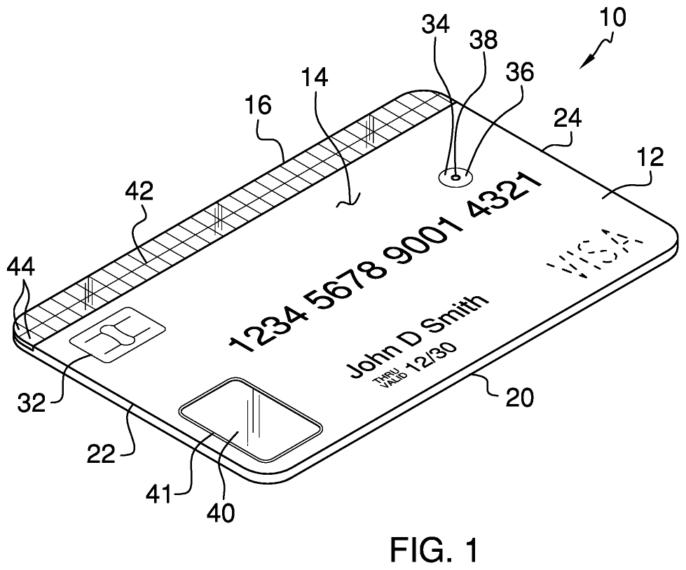

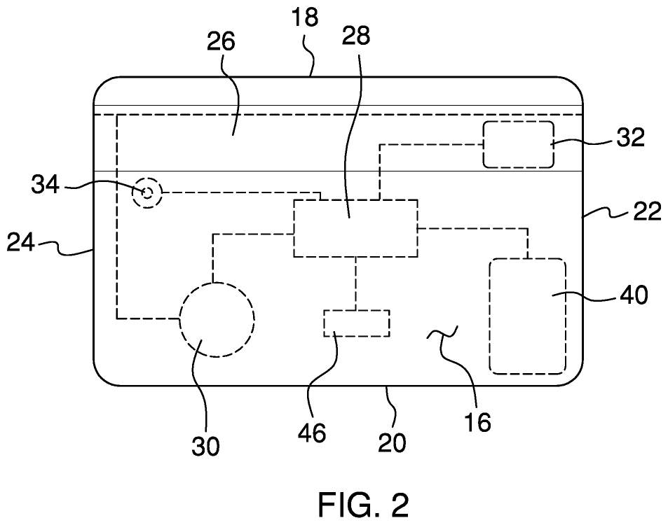

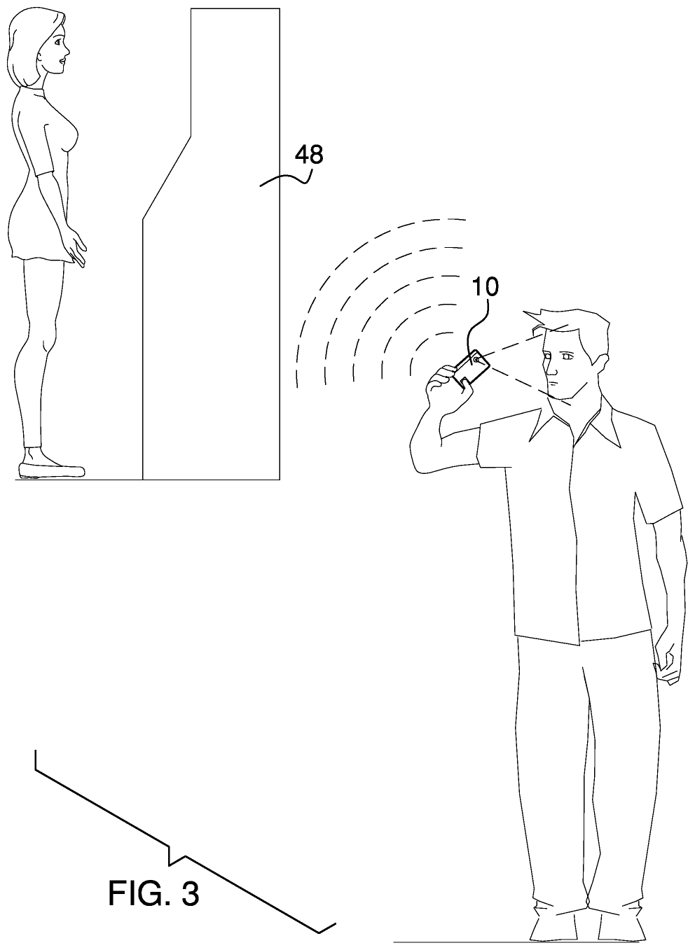

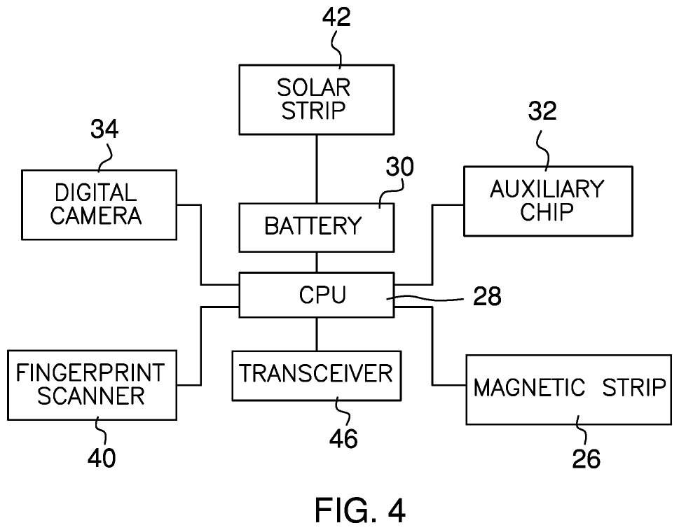

With reference now to the drawings, and in particular to FIGS. 1 through 4 thereof, a new credit card embodying the principles and concepts of an embodiment of the disclosure and generally designated by the reference numeral 10 will be described.

As best illustrated in FIGS. 1 through 4, the credit card authenticator transceiver apparatus 10 generally comprises a card body 12 having a front side 14, a back side 16, a top edge 18, a bottom edge 20, a left edge 22, and a right edge 24, the card body 12 has rounded corners. A magnet strip 26 is coupled to the back side 16 proximal the top edge 18 and stores credit card information in the same manner as a standard credit card magnet strip and is configured to be read by swipe card readers. A CPU 28 and a battery 30 are coupled within the card body 12. The battery 30 is in operational communication with the CPU 28. An auxiliary chip 32 is coupled to the card body 12 and also stores credit card information in the same manner as a standard credit card auxiliary chip and is configured to be read by insert card readers. The auxiliary chip 32 is coupled to the front side 14 adjacent the left edge 22. The auxiliary chip 32 is in operational communication with the CPU 28.

A camera 34 is coupled to the card body 12. The camera 34 extends through the front side 14 and has a circular depression 36 surrounding a pinhole lens 38. The circular depression 36 prevents accidental contact with, and damage to, the pinhole lens 38. The camera 34 is in operational communication with the CPU 28 to provide facial recognition authentication. A finger print scanner 40 is coupled to the card body 12. The finger print scanner 40 is coupled to the front side 14 adjacent the left edge 22 and adjacent the bottom edge 20. The finger print scanner 40 has a frame 41 surrounding a perimeter thereof to prevent accidental contact with, and damage to, the finger print scanner 40. The finger print scanner 40 is in operational communication with the CPU 28. A solar cell strip 42 is coupled to the card body 12. The solar cell strip 42 comprises a pair of rows of solar cells 44. The solar cell strip 42 is coupled to the front side 14 along the top edge 18 and extends from the left edge 22 to the right edge 24. The solar cell strip 42 is in operational communication with, and provides power to, the battery 30. A transceiver 46 is coupled within the card body 12. The transceiver 46 is in operational communication with the CPU 28 and is configured to communicate with a mobile electronic device or an ATM machine 48.

In use, the apparatus 10 functions as a standard credit card and also allows for wireless secure transmission of funds. The user authenticates using facial recognition with the camera 34 and the finger print scanner 40 to allow another user to receive funds at an ATM machine 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A credit card authenticator transceiver apparatus comprising:
a card body having a front side, a back side, a top edge, a bottom edge, a left edge, and a right edge;
a magnet strip coupled to the card body, the magnet strip being coupled to the back side proximal the top edge;
a CPU coupled within the card body;
a battery coupled within the card body, the battery being in operational communication with the CPU;
an auxiliary chip coupled to the card body, the auxiliary chip being coupled to the front side adjacent the left edge, the auxiliary chip being in operational communication with the CPU;
a camera coupled to the card body, the camera extending through the front side, the camera being in operational communication with the CPU, the camera having a circular depression surrounding a pinhole lens wherein the pinhole lens is inset from a planar surface of the front side of the card body;
a solar cell strip coupled to the card body, the solar cell strip being coupled to the front side, the solar cell strip being in operational communication with the battery; and
a transceiver coupled within the card body, the transceiver being in operational communication with the CPU.

2. The credit card authenticator transceiver apparatus of claim 1 further comprising a finger print scanner coupled to the card body, the finger print scanner being coupled to the front side, the finger print scanner being in operational communication with the CPU.

3. The credit card authenticator transceiver apparatus of claim 2 further comprising the finger print scanner being coupled adjacent the left edge and adjacent the bottom edge.

4. The credit card authenticator transceiver apparatus of claim 3 further comprising the finger print scanner having a frame surrounding a perimeter thereof.

5. The credit card authenticator transceiver apparatus of claim 1 further comprising the solar cell strip being coupled along the top edge and extending from the left edge to the right edge.

6. The credit card authenticator transceiver apparatus of claim 5 further comprising the solar cell strip comprising a pair of rows of solar cells.

7. The credit card authenticator transceiver apparatus of claim 1 further comprising the card body having rounded corners.

8. (canceled)

9. A credit card authenticator transceiver apparatus comprising:
a card body having a front side, a back side, a top edge, a bottom edge, a left edge, and a right edge, the card body having rounded corners;
a magnet strip coupled to the card body, the magnet strip being coupled to the back side proximal the top edge;
a CPU coupled within the card body;
a battery coupled within the card body, the battery being in operational communication with the CPU;
an auxiliary chip coupled to the card body, the auxiliary chip being coupled to the front side adjacent the left edge, the auxiliary chip being in operational communication with the CPU;
a camera coupled to the card body, the camera extending through the front side, the camera having a circular depression surrounding a pinhole lens wherein the pinhole lens is inset from a planar surface of the front side of the card body, the camera being in operational communication with the CPU;
a finger print scanner coupled to the card body, the finger print scanner being coupled to the front side adjacent the left edge and adjacent the bottom edge, the finger print scanner having a frame surrounding a perimeter thereof, the finger print scanner being in operational communication with the CPU;
a solar cell strip coupled to the card body, the solar cell strip comprising a pair of rows of solar cells, the solar cell strip being coupled to the front side along the top edge and extending from the left edge to the right edge, the solar cell strip being in operational communication with the battery; and
a transceiver coupled within the card body, the transceiver being in operational communication with the CPU.
